(19) United States
(12) Patent Application Publication
(10) Pub. No.: US 2007/0063136 A1
(43) Pub. Date: Mar. 22, 2007

(54) Optical module

(75) Inventor: Tsung-Wei Chiang, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/474,172

(22) Filed: Jun. 23, 2006

(30) Foreign Application Priority Data
Sep. 16, 2005 (CN) 200510037360.X

(51) Int. Cl. H01J 5/02

(52) U.S. Cl. 250/239

(57) ABSTRACT

An optical module (100) includes a lens barrel assembly (10), at least one lens (20), a filter (50), and a securing mechanism. The lens barrel assembly includes a first barrel (12) and a second barrel (14). The second barrel includes a clapboard (142) extending from an inner periphery thereof. The clapboard has a central hole (148) defined therein and. The first barrel is engagingly received in the second barrel and abuts the clapboard. The at least one lens is received in the first barrel. The filter is received in the central hole of the second barrel. The securing mechanism is received in the first barrel with a first end thereof abutting the filter.

### TECHNICAL FIELD

The present invention generally relates to optical modules used in photography and imaging equipment and, more particularly, to an optical module for a digital camera module.

### BACKGROUND

Currently, digital camera modules are included as a feature in a wide variety of portable electronic devices and, of course, in stand-alone digital camera units. Most portable electronic devices are becoming progressively more miniaturized over time, and digital camera modules are becoming smaller and smaller as result. Nevertheless, in spite of the small size of contemporary digital camera modules, consumers still demand better imaging.

Optical modules used for digital camera modules typically include a barrel, a lens group, a spacer, and a filter. The lens module and the spacer are received in the barrel. The filter is fixedly mounted in the barrel by using, for example, an adhesive, thereby preventing the lens module and the filter from falling out of the barrel. When the adhesive used to adhere the filter to the barrel is dilute it can seep into the lens module via capillary action, thus impairing imaging quality of the optical module.

Therefore, a new optical module is desired in order to overcome the above-described shortcomings.

### SUMMARY

In one embodiment thereof, an optical module includes a lens barrel assembly, at least one lens, a filter, and a securing mechanism. The lens barrel assembly includes a first barrel and a second barrel. The second barrel includes a clapboard extending from an inner periphery thereof. The clapboard has a central hole defined therein. The first barrel is engagingly received in the second barrel and abutting the clapboard. The at least one lens is received in the first barrel. The filter is received in the central hole of the second barrel. The securing mechanism is received in the first barrel with a first end thereof abutting the filter.

Other novel features will become more apparent from the following detailed description when taken in conjunction with the accompanying drawings.

### BRIEF DESCRIPTION OF THE DRAWINGS

Many aspects of the optical module can be better understood with reference to the following drawings. The components in the drawings are not necessarily drawn to scale, the emphasis instead being placed upon clearly illustrating the principles of the present optical module. Moreover, in the drawings, like reference numerals designate corresponding parts throughout the several views.

FIG. 1 is an isometric view of an a digital camera module including an optical module, a holder, and an image pick-up module, in accordance with a preferred embodiment, the optical module including a lens barrel assembly, at least one lens, a spacer, and a filter;

FIG. 2 is an exploded, isometric view of the digital camera module of FIG. 1;

FIG. 3 is a cross-sectional view of the optical module of FIG. 1, showing a first barrel not mounting in a second barrel; and

FIG. 4 is a cross-sectional view of the digital camera module shown in FIG. 1;

### DETAILED DESCRIPTION OF THE EMBODIMENTS

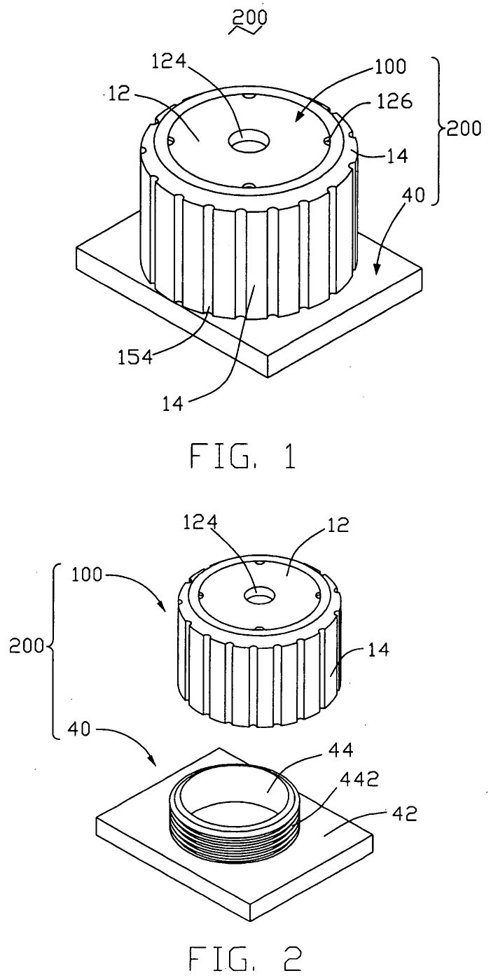

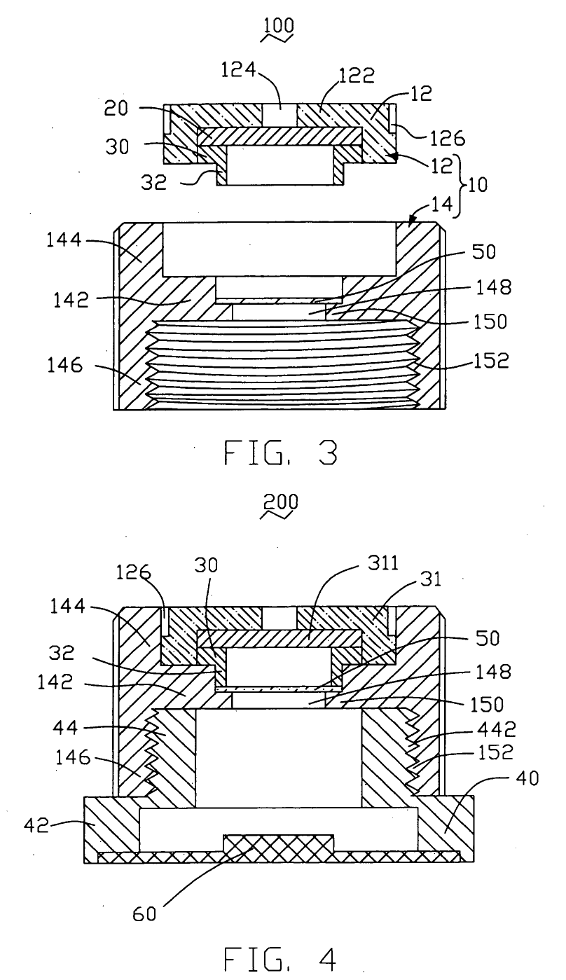

Referring now to the drawings, FIG. 1 shows an optical system such as a digital camera module 200, which includes an optical module 100 (not labelled) for preventing adhesive seeping into a lens of the optical module, according to a preferred embodiment. It should be noted that the optical module 100 may also, for example, be used with other optical systems, such as digital video cameras, image pick-up systems used in cars, infrared optical systems, projection optical systems, and real-time detector systems. The digital camera module 200 is adapted for use in a portable electronic device such as a mobile phone or a personal digital assistant (PDA), but the compact nature thereof could prove useful in compact digital camera units or digital camcorders, as well. Referring also to FIG. 2, the digital camera module 200 includes the optical module 100, a holder 40, and an image pick-up module 60 secured in the holder 40. Referring also to FIG. 3, the optical module 100 includes a lens barrel assembly 10, a spacer 30 functioning as a securing mechanism, and a filter 50. The lens barrel assembly 10 includes a first barrel 12, and a second barrel 14. It is to be understood that lenses of any number and type could be used in the digital optical module 100.

The first barrel 12 is a substantially hollow cylinder, and has at least one lens 20 received therein, having a partially-closed end 122, and an open end (not labeled) on the opposite end to the partially-closed end 122. The partially-closed end 122 defines a hole 124 therein so that light can be transmitted therethrough. The first barrel 12 has four symmetrically spaced notches 126 defined in an outer periphery of the partially-closed end 122. The at least one lens 20 and the spacer 30 are secured in the first barrel 12.

The second barrel 14 is a hollow cylinder in shape with two open ends so that light can be transmitted therethrough. The second barrel 14 includes a clapboard 142 extending from an inner periphery thereof, thus dividing the second barrel 14 into a first cylinder portion 144, and a second cylinder portion 146 integrally formed with the first cylinder portion 144. The clapboard 142 defines a central hole 148 therein so that light can be transmitted therethrough and for receiving the IR-Cut filter 50. The clapboard 142 has a projecting stage 150 projecting from an outer periphery thereof adjacent to a bottom thereof, for supporting the IR-Cut filter 50. The second barrel 14 has an internal thread 152 defined in an outer periphery of the second cylinder portion 146. The second cylinder portion 146 defines a plurality of longitudinal slots 154 in an outer periphery thereof, for facilitating operation of the second barrel 14.

The spacer 30 is substantially ring-shaped. The spacer 30 includes an annular flange 32 axially extending from one end thereof. The spacer 30 is engagingly received in the first barrel 12, with the annular flange 32 extending out of the open end of the first barrel 12. The spacer 30 is configured for adjusting a distance between the lens 20 and other optical elements (for example the filter 50) of the digital camera module 200.

The holder 40 is a hollow cylinder with two open ends so that light can be transmitted therethrough. The holder 40 includes a base 42 and a cylinder portion 44. The holder 40 has external thread 442 defined in an outer periphery of the cylinder portion 44 for engaging with the internal thread 152 of the second barrel 14.

The filter 50 is substantially disk-shaped. The filter 50 is engagingly received in the central hole 148 of the second barrel 14 and supported by the projecting stage 150. The filter 50 is used to selectively transmit light having certain properties, while blocking the remainder. The filter 50 can be selected, for example, from a group consisting of infrared-cut filters and low pass filters.

Referring to FIGS. 3 and 4, in assembly of the digital camera module 200, the lens 20 and the spacer 30 are orderly received in the first barrel 12 via the open end of the first barrel 12. The filter 50 is engagingly received in the central hole 148 of the clapboard 142 of the second barrel 14 and supported by the projecting stage 150. The first barrel 12 is fixingly received in the first cylinder portion 144 of the second barrel 14 by using, for example, an adhesive in the notches 126 of the first barrel 10, with the spacer 30 abutting the lens 20 and the filter 50, thus preventing the lens 20 and the filter 50 becoming separated from the lens barrel assembly 10. The second barrel 14 combined with the first barrel 12, the lens 20, the spacer 30, are rotated around the holder 40 via touching the longitudinal slot 154, with the external thread 442 of the holder 40 engaging with the internal thread 152 of the second barrel 14. The digital camera module 100 is thus completely assembled.

In the above-described assembly processes, because the adhesive is applied in the notches 126 defined in an outer periphery of the first barrel 12, instead of directly applied in an inner periphery of the lens barrel 12, and the filter 50 is secured in the second barrel 14 instead of directly applying an adhesive, thus avoiding pollution of the lens 20. Imaging quality of the digital camera 100 can thus be improved. When the adhesive is dilute, it can only infiltrate into an outer periphery of the first barrel 12, thus preventing it from polluting the lens module 20.

In an alternative embodiment, the notches 126 of the first barrel 12 can be omitted. The first barrel 12 is interferingly received in the second barrel 14, instead of using adhesive, thereby decreasing a manufacturing cost of the digital camera module 200. Imaging quality of the digital camera module can thus be improved.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An optical module, comprising:
a lens barrel assembly including a first barrel and a second barrel, the second barrel including a clapboard extending from an inner periphery thereof, the clapboard having a central hole defined therein, the first barrel being engagingly received in the second barrel and abutting the clapboard;
at least one lens received in the first barrel;
a filter securely received in the central hole of the second barrel; and
a securing mechanism received in the first barrel with a first end thereof abutting the filter.

2. The optical module as claimed in claim 1, wherein the second barrel has a projecting stage extending radially and inwardly from an inner periphery of the clapboard, and the filter is supported by the projecting stage.

3. The optical module as claimed in claim 1, wherein the second barrel further comprises a first cylinder portion, a second cylinder portion, and the clapboard disposed between the first cylinder portion and the second cylinder portion, the first barrel being received in the first cylinder portion of the second barrel.

4. The optical module as claimed in claim 1, wherein the securing mechanism is a spacer.

5. The optical module as claimed in claim 4, wherein the spacer includes an annular flange formed at the first end thereof, the annular flange extends into the central hole of the second barrel and abutting the filter.

6. The optical module as claimed in claim 1, wherein the first barrel has a plurality symmetrically spaced notches defined in an outer periphery thereof and adjacent one end thereof.

7. A lens barrel assembly, comprising:
a first barrel having at least one lens received therein; and
a second barrel, the second barrel including a clapboard extending from an inner periphery thereof, the clapboard having a central hole defined therein, the first barrel being coupled to the second barrel in a manner so as to abut the clapboard and align the at least one lens with the central hole.

8. The lens barrel assembly as claimed in claim 7, wherein the second barrel has a projecting stage extending radially and inwardly from an inner periphery of the clapboard.

9. The lens barrel assembly as claimed in claim 7, wherein the second barrel further comprises a first cylinder portion, a second cylinder portion, and the clapboard disposed between the first cylinder portion and the second cylinder portion, and the first barrel is received in the first cylinder portion of the second barrel.

10. The lens barrel assembly as claimed in claim 7, wherein the first barrel has a plurality spaced notches defined in an outer periphery thereof and adjacent one end thereof.

11. A digital camera module, comprising:
an optical module, comprising:
a lens barrel assembly including a first barrel and a second barrel, the first barrel having at least one lens received therein, the first barrel being engagingly received in the second barrel;
a filter received in the second barrel; and
a holder rotatably engaging with the second barrel; and
an image-pick up module received in the holder for receiving a light signal from the at least one lens.

12. The lens barrel assembly as claimed in claim 11, wherein the second barrel including a clapboard extending from an inner periphery thereof, the clapboard having a central hole defined therein, the filter received in the central hole.

13. The lens barrel assembly as claimed in claim 12, wherein the second barrel has a projecting stage extending radially and inwardly from an inner periphery of the clapboard, the filter is supported by the projecting stage.

14. The digital camera module as claimed in claim 12, wherein the second barrel further comprises a first cylinder portion, a second cylinder portion, and the clapboard disposed between the first cylinder portion and the second cylinder portion, the first barrel being received in the first cylinder portion of the second barrel and abutting the clapboard.

15. The digital camera module as claimed in claim 14, wherein the second cylinder portion defines an internal thread in an inner periphery thereof, and the holder defines an external thread in an outer periphery thereof, the internal thread engaging with the external thread.

16. The digital camera module as claimed in claim 12, further comprising a securing mechanism received in the first barrel with a first end thereof abutting the filter.

17. The digital camera module as claimed in claim 16, wherein the securing mechanism comprises a spacer.

18. The digital camera module as claimed in claim 17, wherein the spacer includes an annular flange formed at the first end thereof, the annular flange extends into the central hole of the second barrel and abuts the filter.

19. The digital camera module as claimed in claim 11, wherein the first barrel has a plurality symmetrically spaced notches defined in an outer periphery thereof and adjacent one end thereof.
